(19) United States
(12) Patent Application Publication
(10) Pub. No.: US 2009/0044727 A1
(43) Pub. Date: Feb. 19, 2009

(54) Epoxy additive composition for cement grouts

(75) Inventors: John Garuti, JR., New York, NY (US); Louis Calvo, Bayshore, NY (US)

Correspondence Address: COHEN, PONTANI, LIEBERMAN & PAVANE LLP, 551 FIFTH AVENUE, SUITE 1210, NEW YORK, NY, 10176, US

(73) Assignee: Super-Tek Products, Inc., Woodside, NY (US)

(21) Appl. No.: 11/893,656

(22) Filed: Aug. 17, 2007

(51) Int. Cl. C04B 24/24

(52) U.S. Cl. 106/802; 524/2

(57) ABSTRACT

This invention provides a kit for producing an epoxy additive useful in making a water-soluble grout, which kit comprises, in separate compartments, (a) an epoxy resin selected from the group consisting of (i) a liquid bisphenol A-type epoxy resin, (ii) a liquid bisphenol F-type epoxy resin, (iii) a liquid epoxy phenol novolacs resin, and (iv) an admixture of two or more of any of (i)-(iii); and (b) a composition comprising an admixture of (i) an amine hardener, (ii) a hydrophobic additive and (iii) water; wherein the composition which results from admixing the epoxy resin of part (a) and the composition of part (b) is clear when dried or cured. This invention also provides a related epoxy additive, water-soluble grout and method for producing same.

Throughout this application, various publications are cited. The disclosure of these publications is hereby incorporated by reference into this application to describe more fully the state of the art to which this invention pertains.

### BACKGROUND OF THE INVENTION

In the tile industry, grouts are used as a bridging material to fill the gaps between tiles as they are laid down. These grouts can vary in composition depending on the application and performance required. Typically, tile grouts can be of the following chemical makeup: cement; cement with redispersible polymer powders; epoxy resins; and furan resins.

Epoxy resin grouts are of particular importance in kitchen areas such as countertops and in restaurants, where stain and chemical resistance properties are required. In addition, epoxy grouts are used in flooring applications and commercial environments where durability and chemical resistance are also important parameters. Thus, stain and chemical resistant epoxy grouts are important products in the flooring and counter top sub-segments of ceramic tile markets.

Epoxy grouts can be of two types: 100% solid epoxies (such as Laticrete International's Spectralock Pro; see, e.g., Freedonia Focus on Ceramic Tile, p. 9, The Freedonia Group (September, 2005)); and water soluble or washable types. The most important of the two are the water washable types which allow for easy clean up after the grout is applied. These grouts are described in ANSI A118.3 (American National Standard Specifications for Chemical Resistant, Water Cleanable Tile-Setting and -Grouting Epoxy and Water Cleanable Tile-Setting Epoxy Adhesive) for the 100% solid chemical resistant epoxies and ANSI 118.8 (American National Standard Specifications for Modified Epoxy Emulsion Mortar/Grout) for the epoxy-portland cement compositions.

There exists a long-felt need in the tile industry for a cost-effective epoxy additive which is clear when dried or cured, and shows superior ability to form water-soluble grout that is stain- and chemical-resistant. The existing technology provides no guidance in how this objective might be achieved.

### SUMMARY OF THE INVENTION

This invention provides a kit for producing an epoxy additive useful in making a water-soluble grout, which kit comprises, in separate compartments,
(a) an epoxy resin selected from the group consisting of (i) a liquid bisphenol A-type epoxy resin, (ii) a liquid bisphenol F-type epoxy resin, (iii) a liquid epoxy phenol novolacs resin, and (iv) an admixture of two or more of any of (i)-(iii); and
(b) a composition comprising an admixture of (i) an amine hardener, (ii) a hydrophobic additive and (iii) water;

wherein the composition which results from admixing the epoxy resin of part (a) and the composition of part (b) is clear when dried or cured.

This invention also provides an epoxy additive useful in producing a water-soluble grout, which additive comprises an admixture of
(a) an epoxy resin selected from the group consisting of (i) a liquid bisphenol A-type epoxy resin, (ii) a liquid bisphenol F-type epoxy resin, (iii) a liquid epoxy phenol novolacs resin, and (iv) an admixture of two or more of any of (i)-(iii);
(b) an amine hardener;
(c) a hydrophobic additive; and
(d) water;

wherein the epoxy additive is clear when dried or cured.

This invention further provides a water-soluble grout comprising an admixture of
(a) cement; and
(b) an epoxy additive comprising an admixture of (i) an epoxy resin selected from the group consisting of (1) a liquid bisphenol A-type epoxy resin, (2) a liquid bisphenol F-type epoxy resin, (3) a liquid epoxy phenol novolacs resin, and (4) an admixture of two or more of any of (1)-(3); (ii) an amine hardener; (iii) a hydrophobic additive; and (iv) water, wherein the epoxy additive is clear when dried or cured.

Finally, this invention provides a method for producing a water-soluble grout comprising the step of admixing cement and an epoxy additive, wherein the epoxy additive comprises an admixture of (i) an epoxy resin selected from the group consisting of (1) a liquid bisphenol A-type epoxy resin, (2) a liquid bisphenol F-type epoxy resin, (3) a liquid epoxy phenol novolacs resin, and (4) an admixture of two or more of any of (1)-(3); (ii) an amine hardener; (iii) a hydrophobic additive; and (iv) water, wherein the epoxy additive is clear when dried or cured.

### DETAILED DESCRIPTION OF THE INVENTION

This invention provides an epoxy additive having unexpectedly advantageous features. The instant additive is useful for making water-soluble cement grout in a cost-effective manner. The additive, which is clear when dried or cured, shows superior ability to form grout that is stain- and chemical-resistant, and thus advantageous for use in kitchens and restaurants. As described below, it has now been discovered that using both a hydrophobic additive and an epoxy resin in the same epoxy additive produces an epoxy additive having a synergistic water repellency effect, thereby rendering it stain-resistant. Because of the clarity of the instant epoxy additive, it does not significantly distort the color of the resulting grout the way an opaque epoxy additive would. It is noted that amine hardeners are typically yellow-brown in color, prohibiting clarity in prior additives.

Specifically, this invention provides a kit for producing an epoxy additive useful in making a water-soluble grout, which kit comprises, in separate compartments,
(a) an epoxy resin selected from the group consisting of (i) a liquid bisphenol A-type epoxy resin, (ii) a liquid bisphenol F-type epoxy resin, (iii) a liquid epoxy phenol novolacs resin, and (iv) an admixture of two or more of any of (i)-(iii); and
(b) a composition comprising an admixture of (i) an amine hardener, (ii) a hydrophobic additive and (iii) water;

wherein the composition which results from admixing the epoxy resin of part (a) and the composition of part (b) is clear when dried or cured.

Epoxy resins that are exemplary of those that can be used in this invention include Bisphenol A and F types based on condensation products with Epichlorohydrin, in 100% solids or in solutions with solvents and or water or in emulsion forms. Other epoxy resins that can be used by themselves or in combination with the above are epoxy phenol novalacs or other multifunctional liquid epoxy resins. Preferred resins are Bisphenol A and F epoxy resins, either blended or by themselves. Examples of commercially available products are GSE Technologies' GSE-170LV, a Bisphenol F type epoxy resin and Shell's 828, a Bisphenol A type epoxy resin. Higher molecular weight versions thereof are envisioned. Additional Bisphenol A type epoxy resins include, for example, Dow's D.E.R.™ 317 Liquid Epoxy Resin and EPON™ Resin 828 by HEXION™. Additional Bisphenol F type epoxy resins include, for example, Dow's D.E.R.™ 354 Liquid Epoxy Resin and EPON™ Resin 863 by HEXION™. Examples of epoxy phenol novolacs resin include, without limitation, ECN 1132 from Ciba-Geigy, EPON™ HPT Resin 1050 and EPON™ Resin 154, both by HEXION™, Dow's D.E.N.™ 425 Epoxy Novolac Resin and EPON™ Resin 160 by HEXION™.

Epoxy resin hardeners that are exemplary of those that can be used in this invention include liquid aliphatic or cycloaliphatic amine hardeners of various molecular weights, in 100% solids or in emulsion or water and solvent solution forms. Amine adducts with alcohols and phenols or emulsifiers are also envisioned. Preferred examples of commercially available hardeners are Air Products Anquawhite™ 100 Curing Agent and EPI-CURE™ Curing Agent 8290-Y-60 by HEXION™.

Hydrophobic additives that can be used in this invention include, without limitation, silanes, siloxanes in solutions or emulsions, Teflon® colloidal suspensions (with or without the presence of other hydrophobic additives such as silanes, siloxanes or waxes), fluoropolymers, wax emulsions or any other hydrophobic additive. Examples of commercially available preferred hydrophobes include, without limitation, Wacker's Silres® BS 290 and Silres® BS 66, and Dupont's Zonyl® PTFE TE 3667N. Hydrophobes in conjunction with the epoxy resin has been found, in this invention, to produce a synergistic water repellency effect in the composition, which yields stain-resistance properties characterizing the instant epoxy additive. Data set forth in the Examples section below show this unexpected result.

In one embodiment of the kit, the epoxy resin is a monomer. In another embodiment, the epoxy resin is not fully polymerized. In a further embodiment, the epoxy resin comprises a Bisphenol A-type epoxy resin or a Bisphenol F-type epoxy resin, and preferably both. In the instant kit, the hydrophobic additive comprises, or consists of, Teflon® in the form of a colloidal dispersion.

Preferably, in the instant kit, the epoxy resin of part (a) and the composition of part (b) each further comprises an anti-foaming agent (such as TEGO® Foamex 840 by Tego Chemie Service GmbH) and a dispersant (such as TAMOL™ 165A by Rohm and Haas).

The epoxy resin and composition of the instant kit can optionally contain general additives such as defoamers (such as NopcoNXZ™), wetting agents (such as Beetle 216™), surfactants (such as TAMOL™ 850) and coupling agents (such as silanes, titanites and zirconates).

When used herein, “clear” shall include, for example, having the property of transmitting light without appreciable color distortion. When used herein, “cured” shall mean fully polymerized. “Water” shall include, without limitation, distilled water, non-distilled water and de-ionized water. When used herein, the terms “admixture” and “blend” shall be synonymous.

This invention also provides an epoxy additive useful in producing a water-soluble grout, which additive comprises an admixture of
(a) an epoxy resin selected from the group consisting of (i) a liquid bisphenol A-type epoxy resin, (ii) a liquid bisphenol F-type epoxy resin, (iii) a liquid epoxy phenol novolacs resin, and (iv) an admixture of two or more of any of (i)-(iii);
(b) an amine hardener;
(c) a hydrophobic additive; and
(d) water;

wherein the epoxy additive is clear when dried or cured.

In one embodiment of the instant epoxy additive, the epoxy resin comprises a Bisphenol A-type epoxy resin or a Bisphenol F-type epoxy resin, and preferably both. In another embodiment of the instant additive, the hydrophobic additive comprises, or consists of, Teflon® in the form of a colloidal dispersion. Preferably, in the instant additive, the epoxy resin of part (a) and the composition of part (b) each further comprises an anti-foaming agent and a dispersant.

This invention further provides a water-soluble grout comprising an admixture of
(a) cement; and
(b) an epoxy additive comprising an admixture of (i) an epoxy resin selected from the group consisting of (1) a liquid bisphenol A-type epoxy resin, (2) a liquid bisphenol F-type epoxy resin, (3) a liquid epoxy phenol novolacs resin, and (4) an admixture of two or more of any of (1)-(3); (ii) an amine hardener; (iii) a hydrophobic additive; and (iv) water, wherein the epoxy additive is clear when dried or cured.

Cement useful in forming the instant grout includes, without limitation, a portland cement such as Castle White Portland Cement by Castle Cement and Lafarge Portland Cement by Lafarge. In one embodiment of the instant grout, the epoxy resin comprises a Bisphenol A-type epoxy resin or a Bisphenol F-type epoxy resin, and preferably both. In another embodiment of the instant grout, the hydrophobic additive comprises, or consists of, Teflon® in the form of a colloidal dispersion. Preferably, in the instant grout, the epoxy resin of part (a) and the composition of part (b) each further comprises an anti-foaming agent and a dispersant.

Finally, this invention provides a method for producing a water-soluble grout comprising the step of admixing cement and an epoxy additive, wherein the epoxy additive comprises an admixture of (i) an epoxy resin selected from the group consisting of (1) a liquid bisphenol A-type epoxy resin, (2) a liquid bisphenol F-type epoxy resin, (3) a liquid epoxy phenol novolacs resin, and (4) an admixture of two or more of any of (1)-(3); (ii) an amine hardener; (iii) a hydrophobic additive; and (iv) water, wherein the epoxy additive is clear when dried or cured.

In one embodiment of the instant method, the epoxy resin comprises a Bisphenol A-type epoxy resin or a Bisphenol F-type epoxy resin, and preferably both. In another embodiment of the instant method, the hydrophobic additive comprises, or consists of, Teflon® in the form of a colloidal dispersion. Preferably, in the instant method, the epoxy resin of part (a) and the composition of part (b) each further comprises an anti-foaming agent and a dispersant.

This invention will be better understood by reference to the Experimental Details which follow, but those skilled in the art will readily appreciate that the specific experiments detailed are only illustrative of the invention as described more fully in the claims which follow thereafter.

### EXAMPLES

Synopsis

This application describes an epoxy additive composition that enhances the stain resistance of cement grouts to surpass that of A118.3 type epoxy grouts, as can be substantiated by the test results presented below. In addition to improvements in performance, this invention provides significant cost savings advantages. Other advantages of this invention are that it is universal, referring to the fact that when used with any cement grout in a suitable proportion readily determined using routine optimization procedures, noticeable improvements are obtained in chemical and stain resistance without significantly altering the original color of the grout.

### Example 1

### General Composition

The following general composition shown in Table 1 has been found to produce stain resistant grouts superior to current state of the art technologies, as can be verified by the test results in the subsequent tables.

TABLE 1

| | Pts by weight |
|---|---|
| Cement grout | 100 |
| Part A | |
| Epoxy Resin | 1 to 5 |
| Part B | |
| Epoxy Resin Hardener | 1 to 10 |
| Hydrophobic Additive | 0.025 to 10 |
| General additive | 0.1 to 2 |

### Example 2

### Comparison of Stain Resistance of Instant Composition with a State of the Art Product

TABLE 2
Stain Resistance*, 4 hr Exposure

| | | | Tomato | |
|---|---|---|---|---|
| Composition | Ketchup | Mustard | Sauce | Wine |
| Novel | No stain left | Very slight | Very slight | Very slight |
| Composition | after | stain left | to no stain | to no stain |
| A | cleaning | after | after | left after |
| | | cleaning | cleaning | cleaning |
| Laticrete | Slight stain | Very slight | Slight stain | Very |
| Spectra lock | left after | stain after | left after | significant |
| State of the | cleaning | cleaning | cleaning | and |
| art product | | | | permanent |
| | | | | stain left after |
| | | | | cleaning |

Novel Composition A consists of the following components.

| Ingredient | Pts by weight | Description |
|---|---|---|
| Poly Grout Plus sanded | 100.00 | Super-Tek product; |
| | | a cement grout |
| Epoxy Part A | | |
| GSE-170LV | 1.64 | Bisphenol F Epoxy Resin |
| Epoxy Part B | | |
| Anquawhite ™ 100 | 3.36 | Water Dispersible Amine |
| TE 3887N | 0.10 | Teflon ® |

### Example 3

### Synergistic Effect of the Hydrophobe in the Epoxy Composition

TABLE 3

| Composition | Water absorption Results** |
|---|---|
| Grout I | Absorption starts at 5 mins |
| | Full absorption at 10 mins |
| Grout I + Hydrophobe A @ 0.5% | Absorption starts at 5 min |
| | Full absorption at 35 mins |
| Grout I + Epoxy Additive A @ 7% | Absorption starts at 10 min |
| | Full absorption at 1 hr |
| Grout I + Hydrophobe A @ 0.5% + | No absorption on the surface |
| Epoxy additive A @ 7% | No absorption after 5 hrs |

Hydrophobe A is a silicone emulsion, BS1001A from Whacker.

Epoxy Additive A consists of the following components.

| Ingredient | Pts by weight |
|---|---|
| Epoxy Part A | |
| GSE-170LV | 100.00 |
| Epoxy Part B | |
| Anquawhite ™ 100 | 206.00 |

### Example 4

### Illustrates the Functionality of the Novel Epoxy Compositions with Various Grouts

TABLE 4
Stain resistance

| Composition | Ketchup | Mustard | Tomato Sauce | Wine | Color |
|---|---|---|---|---|---|
| Polygrout plus | Slight stain | Significant | Very slight | Very | White |
| | | stain | stain | significant | |
| | | | | stain | |
| Polygrout | Very slight | Slight stain | Very slight | Slight stain | Slightly |
| plus with | stain | | stain | | darker |
| Epoxy | | | | | white |
| Additive B | | | | | |
| Laticrete | Significant | Significant | Significant | Very | Off white |
| 1500 | Stain | stain | stain | significant | |
| | | | | stain | |
| Laticrete | Slight stain | Slight stain | Slight stain | Stain left | Darker off |
| 1500 with | | | | | white |
| Epoxy | | | | | |
| Additive B | | | | | |
| Laticrete | Slight stain | Very slight | Slight stain | Very | White |
| Spectralock | | stain | | significant | |
| | | | | stain | |
| Laticrete | None | None | None | Very slight | White |
| Spectralock | | | | | |
| Aggregate | | | | | |
| with Epoxy | | | | | |
| Additive B | | | | | |

Epoxy Additive B consists of the following components.

| Ingredient | Pts by weight |
|---|---|
| Epoxy Part A | |
| GSE-170LV | 1.64 |
| Epoxy Part B | |
| Anquawhite ™ 100 | 3.36 |
| TE 3887N | 0.10 |

A tile grout was constructed with the composition material. The specified kitchen ingredients were poured over the cured grout for 4 hrs [symbol] RT. The cleaning process consisted of a paper towel wipe followed by a soapy sponge cleaning and a water rinse.

The water absorption was evaluated by dropping about 5 gms of water over the area of interest and timing the water penetration.

What is claimed is:

1. A kit for producing an epoxy additive useful in making a water-soluble grout, which kit comprises, in separate compartments,
(a) an epoxy resin selected from the group consisting of (i) a liquid bisphenol A-type epoxy resin, (ii) a liquid bisphenol F-type epoxy resin, (iii) a liquid epoxy phenol novolacs resin, and (iv) an admixture of two or more of any of (i)-(iii); and
(b) a composition comprising an admixture of (i) an amine hardener, (ii) a hydrophobic additive and (iii) water;
wherein the composition which results from admixing the epoxy resin of part (a) and the composition of part (b) is clear when dried or cured.

2. The kit of claim 1, wherein the epoxy resin is a monomer.

3. The kit of claim 1, wherein the epoxy resin is not fully polymerized.

4. The kit of claim 1, wherein the epoxy resin comprises a Bisphenol A-type epoxy resin and/or a Bisphenol F-type epoxy resin.

5. The kit of claim 1, wherein the hydrophobic additive comprises Teflon® in the form of a colloidal dispersion.

6. The kit of claim 1, wherein the hydrophobic additive consists of Teflon® in the form of a colloidal dispersion.

7. The kit of claim 1, wherein the epoxy resin of part (a) and the composition of part (b) each further comprises an anti-foaming agent and a dispersant.

8. An epoxy additive useful in producing a water-soluble grout, which additive comprises an admixture of
(a) an epoxy resin selected from the group consisting of (i) a liquid bisphenol A-type epoxy resin, (ii) a liquid bisphenol F-type epoxy resin, (iii) a liquid epoxy phenol novolacs resin, and (iv) an admixture of two or more of any of (i)-(iii);
(b) an amine hardener;
(c) a hydrophobic additive; and
(d) water;
wherein the epoxy additive is clear when dried or cured.

9. The epoxy additive of claim 8, wherein the epoxy additive comprises a Bisphenol A-type epoxy resin and/or a Bisphenol F-type epoxy resin.

10. The epoxy additive of claim 8, wherein the hydrophobic additive comprises Teflon®.

11. The epoxy additive of claim 8, wherein the hydrophobic additive consists of Teflon®.

12. The epoxy additive of claim 8, further comprising an anti-foaming agent and a dispersant.

13. A water-soluble grout comprising an admixture of
(a) cement; and
(b) an epoxy additive comprising an admixture of (i) an epoxy resin selected from the group consisting of (1) a liquid bisphenol A-type epoxy resin, (2) a liquid bisphenol F-type epoxy resin, (3) a liquid epoxy phenol novolacs resin, and (4) an admixture of two or more of any of (1)-(3); (ii) an amine hardener; (iii) a hydrophobic additive; and (iv) water, wherein the epoxy additive is clear when dried or cured.

14. The grout of claim 13, wherein the epoxy additive comprises a Bisphenol A-type epoxy resin and a Bisphenol F-type epoxy resin.

15. The grout of claim 13, wherein the hydrophobic additive comprises Teflon®.

16. The grout of claim 13, wherein the hydrophobic additive consists of Teflon®.

17. The grout of claim 13, wherein the epoxy additive further comprises an anti-foaming agent and a dispersant.

18. A method for producing a water-soluble grout comprising the step of admixing cement and an epoxy additive, wherein the epoxy additive comprises an admixture of (i) an epoxy resin selected from the group consisting of (1) a liquid bisphenol A-type epoxy resin, (2) a liquid bisphenol F-type epoxy resin, (3) a liquid epoxy phenol novolacs resin, and (4) an admixture of two or more of any of (1)-(3); (ii) an amine hardener; (iii) a hydrophobic additive; and (iv) water, wherein the epoxy additive is clear when dried or cured.

19. The method of claim 18, wherein the epoxy additive comprises a Bisphenol A-type epoxy resin and/or a Bisphenol F-type epoxy resin.

20. The method of claim 18, wherein hydrophobic additive comprises Teflon®.

21. The method of claim 18, wherein hydrophobic additive consists of Teflon®.

22. The method of claim 18, wherein the epoxy additive further comprises an anti-foaming agent and a dispersant.
